(19) United States
(12) Patent Application Publication
(10) Pub. No.: US 2021/0377263 A1
(43) Pub. Date: Dec. 2, 2021

(54) DISTRIBUTED COMPUTING SYSTEMS FOR STRONG USER AUTHENTICATION AND RELATED METHODS

(71) Applicant: LOGIN ID INC., SAN MATEO, CA (US)

(72) Inventor: SIMON LAW, SAN MATEO, CA (US)

(21) Appl. No.: 17/287,657

(22) PCT Filed: Oct. 29, 2019
(86) PCT No.: PCT/US2019/058536

§ 371 Date: Apr. 22, 2021

Related U.S. Application Data
(60) Provisional application No. 62/752,074, filed on Oct. 29, 2018.

(51) Int. Cl. H04L 29/06; H04L 9/32; H04L 9/30

(52) U.S. Cl. CPC H04L 63/0861; H04L 9/3073; H04L 9/3247

(57) ABSTRACT

A distributed computing system is used to form a login network to verify the identity of users. The login network uses biometric authentication on a user device to digitally sign a payload, which is sent to the login network for verification. The login network executes the verification using blockchain computing architecture, which is decentralized. The login network provides strong customer authentication, decentralization of data and authentication, a trusted identity service, and privacy and control of the user data by the user.

### CROSS-REFERENCE TO RELATED APPLICATIONS

This application claims priority to U.S. Provisional Patent Application No. 62/752,074 filed on Oct. 29, 2018 and titled “Decentralized Computing Systems for Strong User Authentication And Related Methods”, the entire contents of which are hereby incorporated by reference.

### TECHNICAL FIELD

The following generally relates to decentralized computing systems for strong user authentication and related methods.

### DESCRIPTION OF THE RELATED ART

The process of authentication has traditionally been based on the exchange of secret information between parties. In the centralized world, username and password has emerged as the fundamental authentication system since the early days of mainframe computers.

This paradigm of computing architecture has continued to this day with the proliferation of software applications (including blockchain platforms) and websites that require users to unlock access to other credentials (e.g. private keys) via the entering of passwords.

In an attempt to remember passwords, customers have resorted to using the same password across multiple applications, creating huge exposure and risk of compromise. Patchwork solutions like password managers and browser form fills have been an attempt to alleviate this issue but does not solve the fundamental problem.

In light of this, individuals, merchants and website owners are resorting to federated logins (e.g. logging in to a merchant website or 3^{rd} party website using the user's Facebook or Google credentials) for access, which while simplifying access for customers, requires trust in these centralized authorities. In addition to clear privacy considerations and data-mining that can occur at these centralized authorities, this type of architecture is also vulnerable to security comprises. A recent example is the Facebook breach announced on Sep. 28, 2018, which illustrates the significant vulnerability around the use of federated logins with centralized authorities.

Facebook revealed that it had suffered a security breach that impacted at least 50 million of its users, and possibly as many as 90 million. Beyond the impact on Facebook accounts themselves, the company confirmed that the breach impacted Facebook's implementation of Single Sign-On, the practice that lets you use one account to log into others.

This is just one challenge amongst others that arises with centralized computing authorities storing (e.g. what is often called ‘protecting’) user credentials, and storing the amount of information they have on users.

Even worse scenarios are when large tech players hide breaches of customer data from their customers, as recently happened with 496,000 Google+ profiles. Furthermore, a centralized computing authority can be hacked, and the centralized architecture does not inherently alert customers and third parties from knowing, unless the centralized computing authority chooses to share that the hack took place. Other examples include major hacks at large companies such as Equifax, Yahoo and Target, and other federated identity players such as LinkedIn, which have further eroded customer trust. FIG. 1 illustrates the dependency that a few centralized computing authorities (e.g. Facebook, Yahoo, Google, LinkedIn, etc.) can have on the ecosystem.

Moreover, federated logins from large tech companies utilize a monetization model around tracking behaviour of customers. Therefore, the more a customer uses federated login at diverse merchants/sites, the more sophisticated a profile of the customer is being built. The more valuable the customer's profile, the more revenue the large tech company can generate off this customer's profile, while the customer does not have sufficient control over how his/her private data is used. This has even greater negative impact on the smaller enterprises that utilize federated logins, since the large tech company now gets insight into the smaller enterprise's business, which may have consequential effects on the smaller company in the long run.

Another byproduct around the use of these federated logins, is that central authorities like Google, Facebook are also treated as trusted identity providers. However, these central authorities do not perform any KYC and if they do, they are very weak. A good example of this is the foreign tampering of US elections using fake personas that were created on Facebook.

The companies who collect sensitive information about a user may also share this information with another 3rd party, sometimes without adequate user consent. The Facebook—Cambridge Analytica controversy in March 2018 (50M user accounts) and Dun and Bradstreet's leak of 33 M US citizens information in March 2017 are very much related to this topic.

The above problems, amongst others challenges, make it difficult for facilitate the secure login of user onto websites, apps, email accounts, etc. in a scalable manner.

### BRIEF DESCRIPTION OF THE DRAWINGS

Embodiments will now be described by way of example only with reference to the appended drawings wherein:

FIG. 1 is a schematic diagram of an example of a user device logging into one or more online systems using a federated login provider.

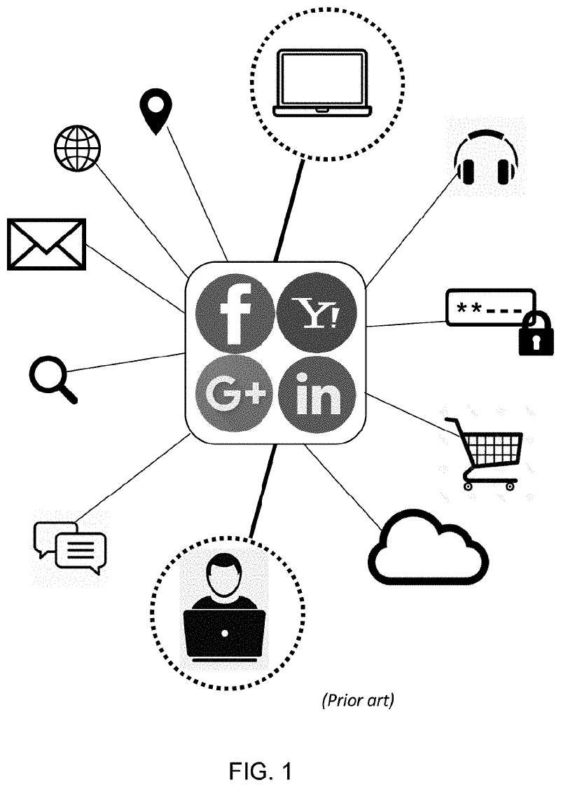

FIG. 2A is a schematic diagram of a login network according to an example embodiment.

FIG. 2B is a flow diagram of computer executable or processor implemented instructions for a user to login into an online system using biometric verification and the login network, according to an example embodiment.

FIG. 3 is a schematic diagram of an example embodiment of a login network, including various nodes, a side chain, and a blockchain.

FIG. 4 is a schematic diagram of computations of various claims related to an Issuer entity, a Holder entity, a Subject entity, and an Inspector entity, according to an example embodiment. These entities, for example, are implemented by respective computing devices.

FIG. 5 is a schematic diagram of the login network, including its various computations and data components, according to an example embodiment.

FIG. 6 is a flow diagram of executable instructions for retrieving personal identifying information using biometric authentication, according to an example embodiment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

It an example aspect, an improved login system is herein provided to address one or more of the problems of federated logins. The improved login system is herein referred to as a login network, which includes a distributed computer network.

In another example aspect, the login network satisfies related regulatory standards. For instance, the European Union has introduced the General Data Protection Regulation (GDPR) to protect consumer's private information, which requires businesses to obtain consent from customers when this data is going to be processed (used) or sent to a 3rd party.

In another example aspect, the login network is simple and easy for users to use, and to do provide a system that is massively scalable. By contrast, it is herein recognized that common existing approaches that require the user to download software, use special browsers, or install plugins, are filled with friction in usability as these are extra steps to the user. To that end, in another example aspect of the login network, the user is not required to manually download and install any special software, while at the same time, the improved login system provides the users with the benefits achievable by the blockchain when compared to a centralized solution.

In an example aspect, the login network is a more secure, frictionless, and decentralized computer platform than what currently exists today for both blockchain applications (smart contracts) and traditional web applications.

In another example aspect, the login network is a trusted source for identity, while also providing capabilities to maintain privacy.

Below are example aspects of the login network, which will be discussed in greater detail in this document.

Strong Customer Authentication (SCA)—authentication is based on the use of two or more elements categorized as knowledge (something only the user knows), possession (something only the user possesses) and inherence (something the user is).

Decentralization—architecture that can provide strong consumer authentication and trusted identity capabilities without dependencies on centralized trust anchors. Additionally, for those users seeking a frictionless experience that do not desire to install any additional software, a derivative architecture that diffuses the customer's data amongst multiple nodes and encrypts the data with a threshold encryption scheme will also be described.

Trusted Identity—getting trusted identity claims of a subject with the consent of the subject is useful for many relying parties. This is in contrast to the identity information that a relying party may get from a centralized service, such as Google or Facebook, where the profile contains unvalidated information from the creator of the profile.

Privacy—the data subject being able to assert their rights regarding their data, while still enjoying the benefits of using a blockchain when compared to a purely centralized solution.

Regulatory compliance—how it will be possible to utilize a decentralized architecture, while at the same time adhering to strict standards designed to protect customers.

### Strong Customer Authentication

The login network includes the feature of Strong Customer Authentication and decentralized trust. Strong customer authentication, according to the European Central Bank is defined as:

A procedure based on the use of two or more of the following elements—categorized as knowledge, ownership and inherence:

(i) something only the user knows, e.g. static password
(ii) something only the user possesses, e.g. token, smart card, mobile phone;
(iii) something the user is, e.g. biometric characteristic, such as a fingerprint, face scan or eye scan.

The strong authentication procedure is designed in such a way as to protect the confidentiality of the authentication data.

In providing Strong Customer Authentication, the login network provides a user experience that is seamless and frictionless to the user. In an example embodiment, the login network does not require the user to download additional software, such as a native application on the user device. By contrast, many other types of authentication software requires downloads, plugins, or other types of customer activities (e.g. filling in data, CAPTCHA, one-time-passcodes, etc.) which add a significant layer of friction to the user-experience and increase the likelihood of abandonment.

In an example embodiment, the login network works natively with the device operating system and the device browser. For example, the login network facilitates Strong Customer Authentication by leveraging biometrics on commodity hardware and software using the FIDO/WebAuthn stack (described in more detail below), which enables the login network to provide a frictionless user experience for the user while retaining strong security and decentralization attributes. In other words, the login network applies biometrics to blockchain applications.

The login network is adapted to follow an industry-based approach, developed by the FIDO Alliance (www.fidoalliance.com) and W3C. FIDO stands for Fast Identity Online.

FIDO has become an emerging standard for enterprise-based authentication and has Board Level participation from industry leading companies across hardware, software and web sectors. Companies such as Google, Intel, Visa, Qualcomm, and Microsoft, among others, are supporters of this industry initiative. Moreover, FIDO focuses on important work in the areas of: standardizing strong customer authentication; defining necessary hardware components; architecture; and certification levels.

FIDO is also collaborating with the World Wide Web Consortium (W3C) in providing strong customer authentication capabilities to users via popular browsers. As part of this collaboration, FIDO specifications have been submitted to W3C resulting in the Web Authentication (WebAuthn) standard. Major web browser platforms (e.g. Google, Microsoft, Mozilla) have also announced their support of WebAuthn, creating a defacto standard for authentication.

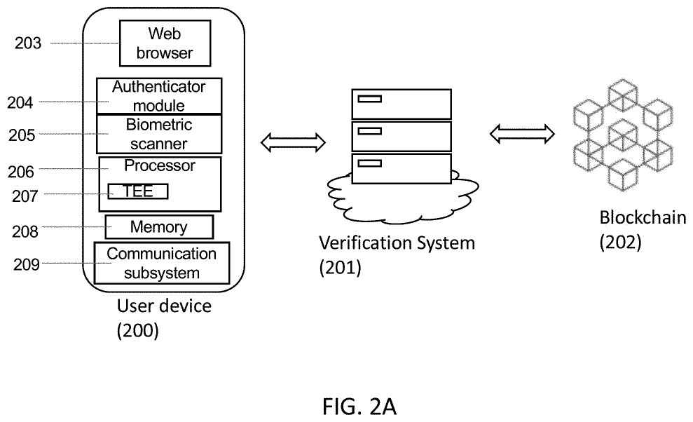

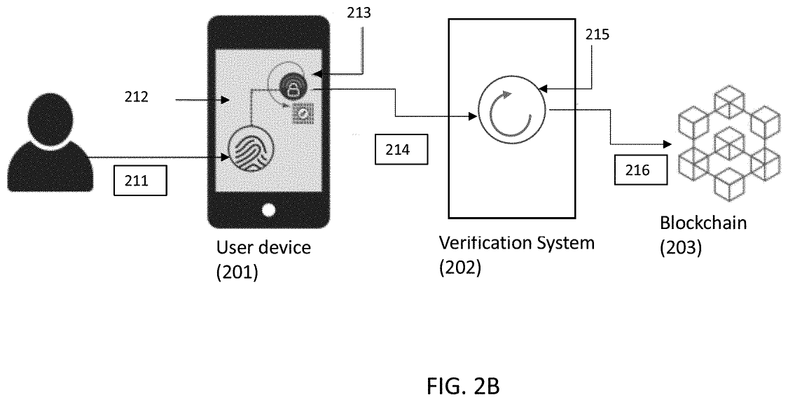

Turning to FIG. 2A, a user device 200 and a verification system 201 are in data communication with each other over the Internet. The verification system 201 is a server system (e.g. a cloud server system) that executes encryption, verification and storage operations. In an example embodiment, the verification system itself is a decentralized network of computing devices. The verification system 201 and a network of other devices that from a decentralized computing network 202 (e.g. a blockchain storage and computing system) are in data communication with each other over the Internet, or another network. Examples of the user device 200 include a mobile phone, a tablet, a laptop, a desktop computer, a smart watch, a wearable computer, etc. The user device 200 includes, amongst other things, a web browser 203, an authenticator module 204, a biometric scanner 205, a processor 206, a Trusted Execution Environment (TEE) 207 that forms part of the processor, memory 208 and a communication subsystem 209. The authenticator module 204, for example, is a FIDO authenticator module that verifies the biometric data from the biometric scanner and generates and has local memory that stores the key pairs. In an example embodiment, on some devices, the authenticator module and the biometric scanner are one module. In an alternative embodiment, the TEE and the authenticator module are one module on some devices. In this document, the different combinations of one or more of the authenticator module, the biometric scanner, and the TEE are also herein called biometric authentication hardware.

Turning to FIG. 2B, an example data system shows the data flow of an authentication process on the login network. In particular, FIDO mechanisms are integrated into the login network architecture. During the authentication process the user will present their biometric (e.g. fingerprint, thumbprint, face scan, eye scan, voice recording, heartbeat, muscle signals, brain signals, etc.) to the user device, shown here as a smart phone, (operation 211) which will verify the biometric data through the local hardware/FIDO Authenticator within the phone (operation 212). After passing the local verification, the FIDO Authenticator will use a securely stored private key that is specific to the user and the verification system, to sign and create a digital signature (operation 213), resulting in a digitally signed authentication payload. This digitally signed authentication payload is sent to the verification system in operation 214 that verifies the signature with the public key retrieved from the blockchain (operation 215) and writes the results to the blockchain (or sidechain) as necessary (operation 216).

In the login network architecture, the verification system in operation 214 is part of the login network's operation or alternatively it can be an operation implemented by another provider that is running the backend code that will be made available as open source code. This way, the user has choices in the endpoint that he/she interacts with. As another safeguard, each such service endpoint/node also has the ability to verify the verification performed by other nodes and submit a fraud proof if necessary to discourage bad behavior.

The user experience of the login network is more secure, frictionless, and portable. It is portable in the sense that a user can initiate this process once and users can subsequently use this authentication across any other different site, application, or smart contract that is part of the login network, without having to setup new credentials. The user experience is also based on industry supported software and hardware, for example using web browsers, operating systems and biometric devices.

### Decentralization

The login network uses a blockchain computing architecture to implement the user authentication.

In an example aspect, blockchain is used to facilitate Strong Customer Authentication utilizing biometrics for other blockchain applications/smart contracts themselves. In other words, as the number of blockchain applications and smart contracts grow, then the login network, which is blockchain-based, can integrate into these applications and smart contract.

In another example aspect, the blockchain computing architecture provides integrity and non-repudiation attributes with data written to the shared ledger that can be independently verified by multiple independent parties, without having to solely rely on a single centralized authority. Transparency in this respect, while still abiding by applicable privacy principles, can be very helpful for relying applications, even if such a relying application itself is mostly centralized. Moreover, consumers are not going to move from centralized applications to decentralized applications overnight. In this respect, the login network helps bridge this gap between centralized applications and blockchain in relation to authentication, authorization, and trusted identity services.

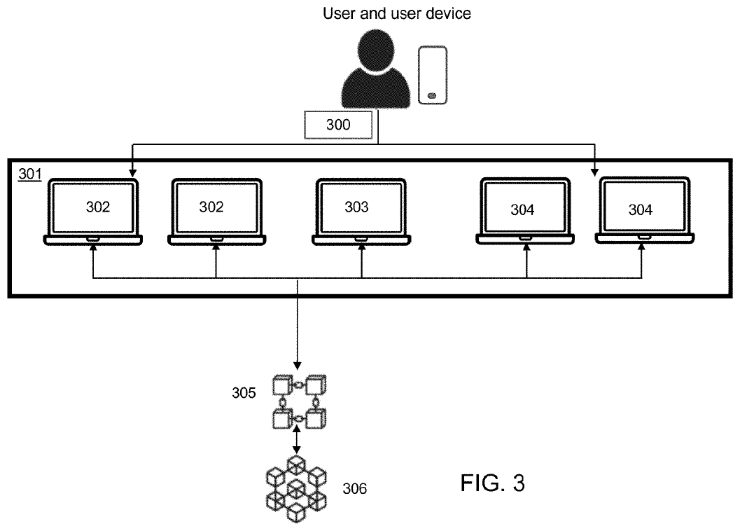

It is important to note that in a blockchain-based solution, the user's public key credentials (or alternatively, a hash of the credentials or a derivative of the credentials) will not be maintained/stored on any centralized server, but maintained on the blockchain, such that any authentication or authorization event can be directly verified not only by the login network servers, but by any other node that receives an authentication payload from the user as can be seen in FIG. 3.

Turning to FIG. 3, the user, via their user device, sends their cryptographically signed user data 300 to the login network 301. The login network 301 includes its own login network nodes 302 (e.g. server machines, or computing devices, or both), and other independent nodes 303, 304 (e.g. other server machines, or other computing devices, or both). In an example embodiment, multiple other independent nodes 304 can form their own independent node service or platform. The data is written to and retrieved from the side chain 305 or the blockchain 306, or both. A side chain in another blockchain technology that is connected to the main blockchain. A side chain is typically called layer 2, and it is used fir fast execution of decentralized apps.

For the relying party (e.g. the user) to receive a level of assurance, the login network performs the verification computation in a trusted execution environment (e.g. leveraging software guard extensions (SGX)) such that any relying parties can receive a level of assurance regarding the verification operation. However, it is natural to ask here “Isn't this just a centralized flow with the public key credentials on the blockchain?”.

The answer is “no”, since the hash of the input data will be written to the blockchain and other independent nodes on the login network that also receives the input data can perform the verification operation and submit fraud proofs as appropriate to punish any bad behavior by any node, including by the servers of the login network themselves.

In an alternative example embodiment, the offloading of the verification operation to an independent secure multi-party computing service (e.g. Enigma), such that the independent computing platform is responsible for providing the level of desired assurance regarding the verification operation. In this latter case, for example, the verification operation is an application running on the independent decentralized computation platform, where the login network servers (or any other independent node on the login network) tunnels the input data to the said secure computation.

Additionally, backed by Strong Customer Authentication, the user is able to manage their credentials at a transactional level, including performing operations in the context of GDPR. The login network provides users with this capability via smart contracts, trusted applications (e.g. in SGX context), and using independent secure multi-party computing platform(s). Such an approach has “trust” related advantages when compared to running the verification logic within a “blackbox” program that would be present in a centralized solution.

Moreover, the login network is an open and agnostic overlay over existing blockchains, with the login network acting as a security layer independent of the underlying blockchain. This allows the user to use the same credentials across multiple consensus networks.

### Trusted Identity

Identity is an accumulation of many aspects of an individual. Many times people disclose far too much personally identifiable information to a relying party that doesn't necessarily require that level of detail. There needs to be industry standardization on how information is communicated and provide more granular control on what particular aspect of the identity that needs to be disclosed. For instance, a relying party may require that someone needs to be over 18 to participate, and requiring the user to disclose their birthday would be unnecessary. For example, a claim like “Alice is over the age of 18” would be sufficient for the relying party.

In addition to how we communicate identity, the login network also details who has issued the statement or claim of the identity. In most cases on the internet today, a user self-claims aspects of our identity (e.g. putting in their name, address, phone number, etc.), which the relying party often implicitly trusts. In order to foster decentralized trust around identity, the login network encourages network participants to issue verifiable claims for other parties. This in aggregate will create a reputational system around identity.

It is important to note that this is not about centralization of trust, but broadening the perimeter of trust such that the trust anchors around such identity claims are not exclusive to a powerful few, but available for all entities that are part of the ecosystem. Here, diversity is key and the platform will enable broad participation.

Fortunately there is an effort to standardize the communication of identity and their claims through the W3C Verifiable Claims working group. Their mission is: “The mission of the Verifiable Claims Working Group (VCWG) is to make expressing and exchanging credentials that have been verified by a third party easier and more secure on the Web.”

And a Verifiable Claim is defined as: “. . . a claim that is effectively tamper-proof and whose authorship can be cryptographically verified. Multiple claims may be bundled together into a set of claims.”

A Verifiable Claim does not need to possess full identity information, but sufficient information about an individual for the verifier to get the essential information needed for the transaction. Verifiable claims will be an integral part of building a holder's identity, and anchored by diverse trust anchors that will be part of the LoginID network.

The Verifiable Claims W3C working group has defined the form and different roles in the model. The W3C documentation identifies 4 roles: Issuer; Verifier (Inspector); Subject; and Holder.

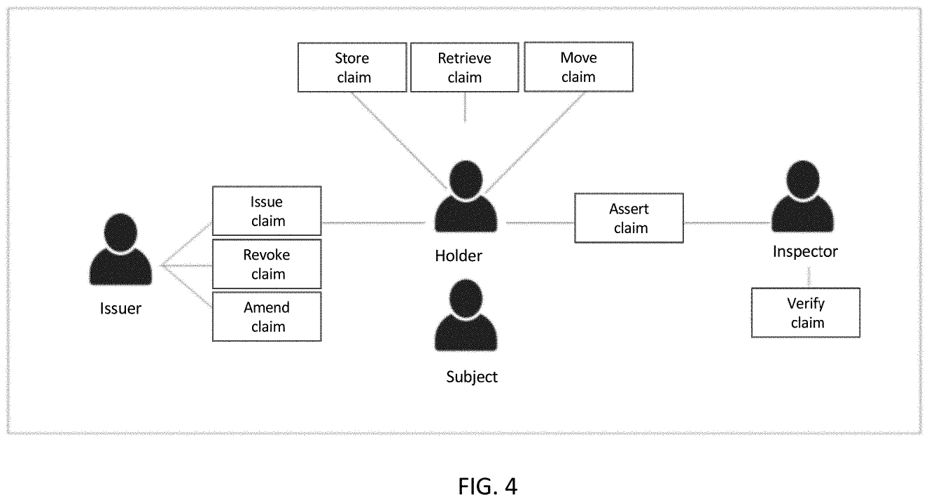

As shown in FIG. 4, the Subject (e.g. child) and the Holder of the issued claim (e.g. parent with the child's health card) need not be the same individual. The Issuer would do the necessary due diligence on the Subject and issue a Verifiable Claim that is held by the Holder. When necessary, the Holder would provide the Verifiable Claim to the Verifier who can verify the claim based on its trust of the Issuer.

There are variations for how Verifiable Claims can be defined, that creates a spectrum of how privacy can be managed around the individual. It can range from pseudo-anonymous to strongly identified. Depending on the scenario, users may only want to share certain information, and what information that can be gleaned from this information provided. This at the same time needs to be balanced with the information that the Verifier requires.

User credentials (e.g. FIDO public key) can also be directly embedded in a Verifiable Claim, such that the user can perform transactions using the corresponding private key that will be associated with the identity as specified in the Verifiable Claim. Depending on context, in some cases, single-use credentials can be issued to an individual whose identity is not known and this can be ok (e.g. movie tickets). However, in other cases, knowing the identity of the individual that gets the credential is important (e.g. employee getting clearance to top secret data).

If the Verifiable Claim is issued by an untrustworthy party, the Verifiable Claim does not have much value. This also extends to the case where the Holder or Subject asserts a Verifiable Claim against the Subject (similar to a self-signed certificate in a PKI framework).

Also, different Issuers of Verifiable Claims can have different levels of assurance. Depending on the risk appetite of the Verifier and the cost of the particular Verifiable Claim, a Holder and/or Verifier may choose one or more suitable Issuer(s). For example, getting a Verifiable Claim issued by the government will likely be more expensive than getting it issued by a local Notary Public. As such, the Verifier may decide that it is willing to accept the Verifiable Claim issued by a local Notary Public instead of requesting a verifiable claim that is issued directly by the government.

There are a number of existing platforms that provide these types of ‘know your customers’ (KYC) capabilities. The login network can leverage these KYC platforms to create verifiable claims with high assurance levels, but will also actively seek to onboard other diverse Issuer participants. In an example aspect, to encourage partners to participate, an incentivized system is implemented for the creation of accurate, Verifiable Claims. Since the Verifier will most likely not be able to keep track of all the Issuers within the network, a reputational scoring system will be a component to augment the Verifiable Claim platform. As the network of reputation grows and more transactions are completed, reputational scores will be more accurate, making the Verifiable Claims even more dependable, particularly in relation to Issuers that are not as well known.

### Privacy

As discussed previously, Strong Customer Authentication and Trusted Identity mechanisms are valued capabilities in the decentralized world. In addition, ensuring privacy is also essential for any platform that provides these capabilities.

Achieving these features on the login network, which, for example, is a public permissionless blockchain, yields different considerations and challenges especially in relation to providing sufficient privacy. By way of background, there are other types of architectures, including centralized data architectures and private permissioned blockchains.

There are three aspects in an information secure system: 1) confidentiality, 2) integrity, and 3) availability (i.e. also sometimes called the CIA triad). Providing sufficient privacy in a system is very much tied to these principles, since only authorized entities should be able to view, make changes, and manage the data belonging to a data subject, while being able to do those actions within reasonable timelines.

Moreover, in relation to ensuring confidentiality and integrity of the data, the data needs to be protected for when the data is at-rest, in-transit, and in-use. One of way achieving this for data-in-use is to process confidential information only in trusted execution environments.

A trusted execution environment (TEE) is a secure area of a main processor. It guarantees code and data loaded inside to be protected with respect to confidentiality and integrity. A TEE as an isolated execution environment provides security features such as isolated execution, integrity of applications executing with the TEE, along with confidentiality of their assets.

Within the login network, personal data that is subject to privacy protections will only be managed within (i) TEE(s) of a login network node whose behavior can be validated by other nodes of the login network or (ii) an application running on an independent decentralized multi-party computation platform (e.g. Enigma), (iii) on a relying-party endpoint that requires visibility into the personal data via a login network module (e.g. a merchant server), and/or (iv) a native application on the user's personal device.

There are pros and cons to each of these architecture variations, primarily around friction and usability vs security. For example, approach (iv) above would require the user to download a native application to the user's personal device. Despite the friction of requiring a download, this flow will be an available option to those users who will find its security properties desirable. In the other architectures that do not rely on a native application on the user's personal device, specifically approaches (i) and (ii) above, the execution environment provides assurances regarding the integrity of their computations to the other nodes on the login network.

With respect to data-in-transit, the login network uses public keys associated with the various endpoints (with sufficient trusted attestation of the said public keys) to provide end-to-end encryption and integrity. In an example embodiment, in addition to this message level (OSI Layer 7) encryption, Transport Layer Security (TLS) is utilized whenever the interaction makes this possible.

This leaves the problem of confidentiality and integrity for data-at-rest. As discussed previously in this document, storing sensitive data within centralized databases can yield disastrous results if there is a breach. That said, storing user data (even in encrypted form) on a public blockchain is also not appropriate since that inherently bypasses many of the perimeter and internal security controls that are present on a centralized service (e.g. firewalls, IDS) and potentially just “hands over” the encrypted data to an attacker. Even if the data obtained by an attacker is encrypted, it may still be very valuable to an attacker in this form. For example, Amazon does not make their encrypted customer data available in a S3 bucket for downloading—despite Amazon having sole control over the decryption keys. Security is built as a layered infrastructure, where encryption is just one of the layers.

In an example aspect, the login network stores sensitive data both on (i) the blockchain, where distributed decryption key shares ensure that only the intended recipient can access the plaintext data and (ii) a private endpoint (the “Trusted Agent”), whether it be a native application on the user's personal device or a cloud agent of the user. The login network implements a blend of the two approaches, where the data is diffused between the Trusted Agent and the blockchain, such that the management and viewing of the sensitive data requires the involvement of both the Trusted Agent and blockchain nodes. This storage and computation process is herein referred to as “data diffusion”.

In an example embodiment, data diffusion includes, upon receiving the user's private data, splitting the data bit-by-bit via an XOR operation with a One Time Pad (OTP), such that the XOR'd data is stored on the Trusted Agent while the OTP is stored securely on the blockchain. For example, the Trusted Agent could be a cloud service (e.g. provided by LoginID.IO) or a native application running on the user's personal device, at the preference of the user.

The OTP is securely stored on the blockchain using an encryption threshold scheme where the key shares to encrypt the OTP would be generated using a Distributed Key Generation algorithm. Additionally, this protocol uses at least a minimum level of diversity within the node set. The use of a threshold mechanism also ensures that even if some of the nodes become unavailable, then a subset of the remaining nodes can come together to provide the necessary partial plaintexts (i.e. decryption shares) to recover the OTP at the intended recipient.

This approach is also useful, for example, in relation to the “right to be forgotten” requirements of GDPR. While the data written to the blockchain is immutable, the data retained by the Trusted Agent is not and the deletion of the data retained by the Trusted Agent would be sufficient to make the plaintext inaccessible.

If the Trusted Agent is a native application on the user's device, an attacker will have a difficult time launching a scalable attack as he/she would need to compromise individual personal devices. If the Trusted Agent is the login network's cloud service (e.g. at the election of the user), there will be numerous perimeter and internal controls that the attacker would need to overcome to recover the data stored on the login network's native servers. In both cases, the attacker would still need to compromise the minimum threshold of nodes on the blockchain to acquire the other complementary data that is needed to recover the plaintext due to the data diffusion as described above.

### Regulatory Compliance

The industry standard approach mitigates the issues listed above, providing a path for supporting an authentication layer with Strong Customer Authentication, industry recognition, regulatory approval, and ecosystem support.

Because of the industry support behind FIDO, government entities are now recognizing FIDO as a regulatory compliant solution. Moreover, as discussed in the previous section, the login network approach described herein is also compliant with GDPR. For example, a crucial component of the data being stored on the Trusted Agent allows compliance with the “right to be forgotten” provisions of GDPR. The end goal is to create a GDPR compliant solution for storing private data, and offload the cost of compliance to the login network. There are significant costs associated with non-compliance of GDPR requirements for EU-based enterprises, with penalties running as high as 4% of a company's global revenue. In another example aspect, the login network provides a foundation to support digital signatures regulations, such as eIDAS, which provides the goal of recognizing digital signatures as legally binding.

### Example Applications

The login network can be used for one or more of the following example applications: distributed applications (DApps), multi-signature wallet support, website login, digital contract execution, identity verification, e-commerce, payments, contract signing, and supply chain management.

In an example aspect, the login network provides Strong Customer Authentication, while supporting a frictionless user experience

In another example aspect, the login network provides decentralization by utilizing blockchain technologies. In doing so, the login network has benefits related to security as well as not being subject to ‘blackbox’ business logic within the centralized systems, which is hidden from the user

In another example aspect, the login network provides trusted identity, which is useful to ensure users are who they claim they are, and the login network provides this in a way where the control over the data is with the user. This can be achieved with the network's support for Verifiable Claims.

In another example aspect, the login network provides privacy and user control of their own information and data.

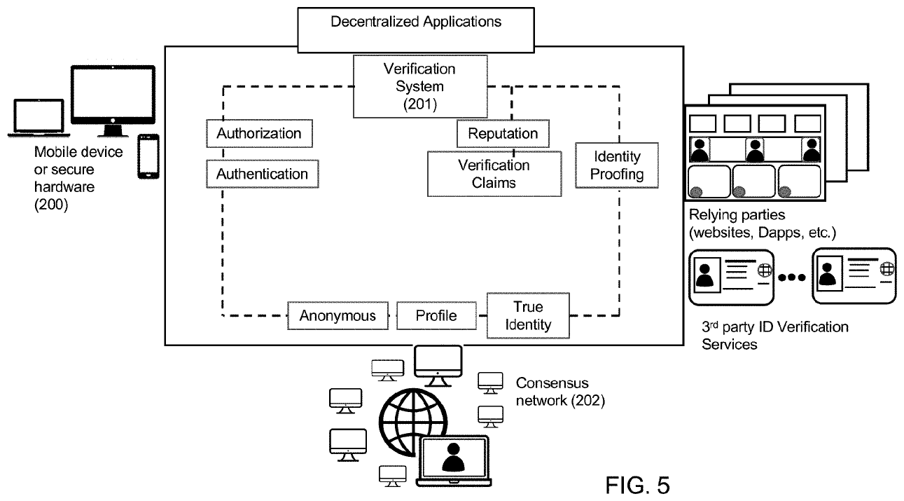

As shown in FIG. 5, the login network enables decentralized entities to verify each other and authorize transactions, and to do so in a regulatorily recognized fashion and without being dependent on a particular centralized authority. Relying parties are free to determine which of one or more issuing authorities deserve their trust to issue a Verifiable Claim depending on context and the login network enables this without giving disproportionate power to specific centralized authorities. Moreover, the login network itself is not centralized, as independent entities are free to participate in the login network.

As an example, Alice and Bob can now verify each other directly, using context dependent decentralized trust, where certain aspects of Bob's identity is attested to by Charlie, Darpa, and Emma. Using the login network, alternative sources of identity information (e.g. telcos, credit bureaus, banks, local governments, even your neighbors next door) can be used to provide the requisite attestation to a claim.

In addition to knowing who is on the other side of a transaction, the login network also provides a mechanism for the parties to authenticate and authorize transactions in a way that is regulatory recognized via WebAuthn/FIDO, and enables a user experience with very little friction.

Another example feature of the login network is that it runs decentralized applications to provide services to relying parties. Another example feature is that the login network provides authentication as a service. Another example feature is that the login network provides identity verification systems that anchor identity proofing; this, for example, facilitates verifiable claims as a service. Another example feature is that the login network includes reputation services, which helps to build a web of trust. Another example feature is that all the services associated with the login network are anchored on top of an anonymous identity or a true identity. Another example feature is that authentication tokens are transferred from the relying party to login services, via the login network. Another example feature is that authentication tokens are transferred from the decentralized applications to the consensus network via the login network.

### Users-Related Example Features

In an example aspect, the authentication provided by the login network puts control and trust of authentication details back into the customers hands.

In another example aspect, control of the customer data will not be part of the login network, providing the customer control of their own personal information.

In another example aspect, the login network mitigates data breaches associated with a ‘centralized’ server repository, while also satisfying regulatory (e.g. GDPR) compliance.

In another example aspect, users are reassured since the login network adheres to the industry standard FIDO protocol providing Strong Customer Authentication.

In another example aspect, by not using a ‘federated login’, the login network does not feed behaviour tracking/targeting engines of large tech company ad platforms, thus protecting customer privacy.

### Example Features Related to 3rd Parties (e.g. Developers, Merchants, Organizations, etc.)

In an example aspect, 3^{rd} parties are now able to use the login network (i.e. a decentralized network) for authentication and identity, eliminating dependencies associated with traditional central authorities.

In an example aspect, 3^{rd} parties can deploy smart contracts with Strong Customer Authentication and regulatory compliance via the login network.

In another example aspect, 3^{rd} parties use the login network as an industry driven, standardized approach to authentication with an open-source implementation that solves the potential problem of fragmentation of relying parties implementing their own authentication stack.

In another example aspect, 3^{rd} parties easily incorporate the login network as a cryptographic solution to their website or application by adding a few lines of code—empowering customers to use their biometrics to secure personal information.

In another example aspect, 3^{rd} parties use the login network as an alternative to the existing ‘federated login’ provided by large tech companies. Therefore, 3^{rd} parties will not be providing their data to a potential competitor in Facebook, Google etc, thus protecting their business and client identity.

In another example aspect, 3rd parties use the login network to record and access an anonymous audit trail, including without limitation recording and accessing proof of login information or other identity components.

In an example embodiment, there are multiple distributed computers that form at least part of the login network. The login network receives a digitally signed payload from a user device, wherein the digitally signed payload is signed by biometric authentication hardware on the user device. A blockchain is in communication with the login network. After the plurality of distributed computers verifies the digitally signed payload, the plurality of distributed computers initiate at least one of a read operation and a write operation to occur on the blockchain based on data provided in the digitally signed payload.

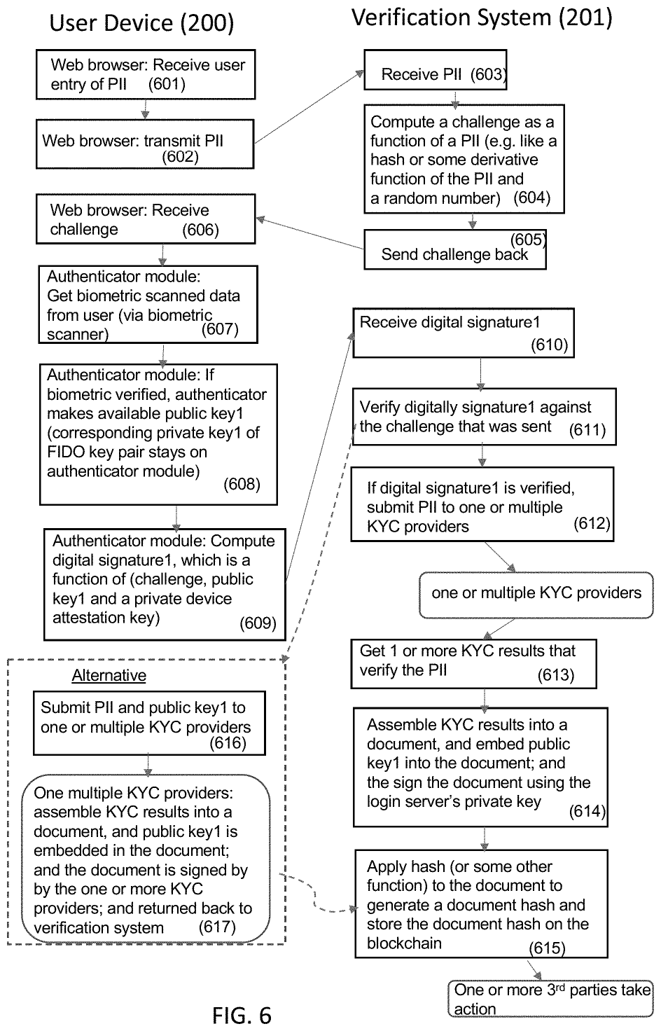

An example process for verification is shown in FIG. 6. In particular, the web browser on the user device receives user input of personal identifying information (PII) such as (e.g. name, address, phone number, account information, citizenship, etc.) at block 601. At block 602, the web browser transmits the PII to the verification system 201. The verification system receives the PII (block 603) and then computes a challenge as a function of the PII (block 604). For example, the challenge is computed by computing an intermediary output that combines the PII and a random number, and then applying a hash or some other function to the intermediary output. This random number and the function are stored as part of the session. The computed challenge is then sent back to the user device (block 605). The web browser receive the challenge (block 606). On the user device, the authenticator module, which is in communication with the web browser, gets biometric scanned data from the user (e.g. via the biometric scanner) (block 607).

At block 608, if the biometric scanned data is verified, the authenticator module makes available a public key1 and a private key1, which together from the FIDO key pair. The private key1 stays on the authenticator module of the user device.

At block 609, the authenticator module computes a digital signature1 (e.g. a digital payload), which is a function of the challenge, the public key1 and a device attestation private key. The device attestation private key is stored on the device and it corresponds to a device attestation public key. These public and private devices attestation keys are unique to a class of devices. The device attestation public key is available to the verification system 201. This digital signature1 is sent to the verification system (block 610).

At block 611, the verification system verifies the digital signature1 against the challenge that was sent. For example, this verification is based on determining if the challenge received in the digital signature1 is the same challenge that was sent at block 605. The verification of the digital signature1 also includes using the device attestation public key.

If the digital signature1 is verified, then the verification system submits the PII to one more multiple KYC providers (block 612) and these one or multiple KYC providers return 1 or more KYC results that verify the PII (block 613).

For example, for a first type of data (e.g. name), a first KYC provider is used to verify the given data that forms part of the PII. For a second type of data (e.g. address), a second KYC provider is used to verify the given data that forms part of the PII. For a third type of data (e.g. date of birth), a third KYC provider is used to verify the given data that forms part of the PII.

The verification system assembles the KYC results into a document, and the verification system embeds the public key1 into the document. It then signs the document using the verification system's private key (block 614).

The document is then encrypted using a hash or some other function, and the encrypted document is stored on the blockchain (block 615). One or more 3^{rd} parties can access this information or portions of this information via verification system 201, or it can obtain a verification of the PII data, and take action with respect to the user.

In an alternative embodiment, after block 611, the process continues to block 616, where the verification system submits the PII and public key1 to the one or more multiple KYC providers. At block 617, the one or multiple KYC providers assemble the KYC results into a document, and then embed the public key1 in the document. The document is then signed by the one or more KYC providers, and returned back to verification system 201. The process then continues to block 615.

In an example embodiment, there are multiple KYC providers that provide data for the same types of data. For example, two entities can verify the data of birth of a person. The verification system 201 sends the date of birth of a person to a first KYC provider and a second KYC provider. If both KYC providers verify the data, then the session proceeds. However, if one KYC provider does not verify the date of birth provided, then the whole verification session is denied.

In another general example embodiment, a computing system is provided that includes a server system that form at least part of a login network, and wherein the login network receives user information from a user device, computes and sends to the user device a challenge that is a function of the user information, and receives a digitally signed payload from the user device that is signed by biometric authentication hardware on the user device. The computing system also includes a blockchain in communication with the login network, wherein after the server system verifies the digitally signed payload using data that includes the challenge, the server system initiates a write operation to occur on the blockchain based on data provided in the digitally signed payload.

In an example aspect, the challenge is computed by generating an intermediary output that is a combination of the user information and a random number, and then applying a hash or another function to the intermediary output.

In another example aspect, the digitally signed payload includes a public key generated by the biometric authentication hardware; and wherein after the server system verifies the digitally signed payload using data that includes the challenge, the server system verifies the user information with one or more Know Your Client (KYC) providers; and after having received one or more results that the user information is verified by the one or more KYC providers, the server system stores the user information and the public key into a document, applies a hash or another function to the document to generate a document hash; and stores the document hash on the blockchain.

In another example aspect, the public key corresponds to a private key also generated by the authenticator module, and the public key and the private key form a Fast Identity Online (FIDO) key pair.

In another example aspect, the user information and the challenge are respectively received and sent via a web browser on the user device.

In another example aspect, the biometric authentication hardware includes a fingerprint scanner.

In another example aspect, the biometric authentication hardware includes one or more of a face scanner and an eye scanner.

In another example aspect, a computer that forms part of the blockchain verifies verification processes performed by the server system.

In another example aspect, the digitally signed payload includes a public key generated by the biometric authentication hardware; and wherein after the server system verifies the digitally signed payload using data that includes the challenge, the server system transmits the user information and the public key to one or more Know Your Client (KYC) providers and, in response, receives a document that comprises the user information and the public key, and is digitally signed by the one or more KYC providers.

In another example aspect, the server system applies a hash or another function to the document to generate a document hash; and stores the document hash on the blockchain.

In a general example embodiment, a computing system is provided that includes: a server system that forms at least part of a login network, and wherein the login network receives user information from a user device, computes and sends to the user device a challenge that is a function of the user information, and receives a digitally signed payload from the user device that is signed by an authenticator module, which uses biometric data, on the user device; and wherein the digitally signed payload includes a public key generated by the authenticator module; and wherein after the server system verifies the digitally signed payload using data that includes the challenge, the server system verifies the user information with one or more Know Your Client (KYC) providers; and after having received one or more results that the user information is verified by the one or more KYC providers, the server system stores the user information and the public key into a document, and applies a hash or another function to the document to generate a document hash.

In an example aspect, the computing system further includes a plurality of computers that form a blockchain, and the server system stores the document hash on the blockchain.

In another example aspect, the challenge is computed by generating an intermediary output that is a combination of the user information and a random number, and then applying a hash or another function to the intermediary output.

In another example aspect, the public key generated by the authenticator module corresponds to a private key of a Fast Identity Online (FIDO) key pair.

In another example aspect, the digitally signed payload is signed as a function of the challenge, the public key and a device attestation private key, and the server system verifies the digital signature using data that includes the challenge and a device attestation public key that corresponds to the device attestation private key.

In a general example embodiment, a system includes a user device and a verification system. The user device includes a web browser that receives user information, transmits the user information to the verification system, and receives back a challenge; and an authenticator module and a biometric scanner. The authenticator module: obtains the challenge from the web browser, wherein the challenge produced by the verification system and the challenge is a function of the user information; obtains biometric data via the biometric scanner; verifies the biometric data; provides a public key and a private key; and computes a digital signature using a device attestation private key. The web browser returns the digital signature to the verification system in response to the challenge.

In an example aspect, the public key and the private key form a Fast Identity Online (FIDO) key pair, and the private key remains secured on the authenticator module.

In another example aspect, the user device further includes a main processor that includes a Trusted Execution Environment (TEE), and the authenticator module resides in part on the TEE.

In another example aspect, the digital signature includes a public key generated by the authenticator module; and wherein after the verification system verifies the digital signature using data that includes the challenge, the verification system verifies the user information with one or more Know Your Client (KYC) providers; and after having received one or more results that the user information is verified by the one or more KYC providers, the verification system stores the user information and the public key into a document, and applies a hash or another function to the document to generate a document hash.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the servers or computing devices or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

1. A computing system is provided comprising:
a server system that form at least part of a login network, and wherein the login network receives user information from a user device, computes and sends to the user device a challenge that is a function of the user information, and receives a digitally signed payload from the user device that is signed by biometric authentication hardware on the user device; and
a blockchain in communication with the login network, wherein after the server system verifies the digitally signed payload using data that includes the challenge, the server system initiate a write operation to occur on the blockchain based on data provided in the digitally signed payload.

2. The computing device of claim 1 wherein the challenge is computed by generating an intermediary output that is a combination of the user information and a random number, and then applying a hash or another function to the intermediary output.

3. The computing device of claim 1 wherein the digitally signed payload includes a public key generated by the biometric authentication hardware; and wherein after the server system verifies the digitally signed payload using data that includes the challenge, the server system verifies the user information with one or more Know Your Client (KYC) providers; and after having received one or more results that the user information is verified by the one or more KYC providers, the server system stores the user information and the public key into a document, applies a hash or another function to the document to generate a document hash; and stores the document hash on the blockchain.

4. The computing device of claim 3 wherein the public key corresponds to a private key also generated by the authenticator module, and the public key and the private key form a Fast Identity Online (FIDO) key pair.

5. The computing system of claim 1 wherein the user information and the challenge are respectively received and sent via a web browser on the user device.

6. The computing system of claim 1 wherein the biometric authentication hardware includes a fingerprint scanner.

7. The computing system of claim 1 wherein the biometric authentication hardware includes one or more of a face scanner and an eye scanner.

8. The computing system of claim 1 wherein a computer that forms part of the blockchain verifies verification processes performed by the server system.

9. The computing device of claim 1 wherein the digitally signed payload includes a public key generated by the biometric authentication hardware; and wherein after the server system verifies the digitally signed payload using data that includes the challenge, the server system transmits the user information and the public key to one or more Know Your Client (KYC) providers and, in response, receives a document that comprises the user information and the public key, and is digitally signed by the one or more KYC providers.

10. The computing device of claim 9, wherein the server system applies a hash or another function to the document to generate a document hash; and stores the document hash on the blockchain.

11. A computing system is provided comprising:
a server system that forms at least part of a login network, and wherein the login network receives user information from a user device, computes and sends to the user device a challenge that is a function of the user information, and receives a digitally signed payload from the user device that is signed by an authenticator module, which uses biometric data, on the user device; and
wherein the digitally signed payload includes a public key generated by the authenticator module; and wherein after the server system verifies the digitally signed payload using data that includes the challenge, the server system verifies the user information with one or more Know Your Client (KYC) providers; and after having received one or more results that the user information is verified by the one or more KYC providers, the server system stores the user information and the public key into a document, and applies a hash or another function to the document to generate a document hash.

12. The computing system of claim 11 further comprising a plurality of computers that form a blockchain, and the server system stores the document hash on the blockchain.

13. The computing system of claim 11 wherein the challenge is computed by generating an intermediary output that is a combination of the user information and a random number, and then applying a hash or another function to the intermediary output.

14. The computing system of claim 11 wherein the public key generated by the authenticator module corresponds to a private key of a Fast Identity Online (FIDO) key pair.

15. The computing system of claim 11 wherein the digitally signed payload is signed as a function of the challenge, the public key and a device attestation private key, and the server system verifies the digital signature using data that includes the challenge and a device attestation public key that corresponds to the device attestation private key.

16. A system comprising a user device and a verification system, the user device comprising:
a web browser that receives user information, transmits the user information to the verification system, and receives back a challenge;
an authenticator module and a biometric scanner, wherein the authenticator module:
obtains the challenge from the web browser, wherein the challenge produced by the verification system and the challenge is a function of the user information;
obtains biometric data via the biometric scanner;
verifies the biometric data;
provides a public key and a private key;
computes a digital signature using a device attestation private key; and
the web browser returns the digital signature to the verification system in response to the challenge.

17. The system of claim 16 wherein and the public key and the private key form a Fast Identity Online (FIDO) key pair, and the private key remains secured on the authenticator module.

18. The system claim 16 further comprising a main processor that includes a Trusted Execution Environment (TEE), and the authenticator module resides in part on the TEE.

19. The system of claim 16 wherein the digital signature includes a public key generated by the authenticator module; and wherein after the verification system verifies the digital signature using data that includes the challenge, the verification system verifies the user information with one or more Know Your Client (KYC) providers; and after having received one or more results that the user information is verified by the one or more KYC providers, the verification system stores the user information and the public key into a document, and applies a hash or another function to the document to generate a document hash.
